(19) United States
(12) Patent Application Publication
(10) Pub. No.: US 2024/0128567 A1
(43) Pub. Date: Apr. 18, 2024

(54) BATTERY SYSTEM, BATTERY MODULE AND BATTERY STRING

(71) Applicant: instagrid GmbH, Ludwigsburg (DE)

(72) Inventors: Andreas SEDLMAYR, Pforzheim (DE); Rachel Dias CARLSON, Heidelberg (DE); Robert RIEGRAF, Ludwigsburg (DE)

(21) Appl. No.: 18/289,694

(22) PCT Filed: Apr. 27, 2022
(86) PCT No.: PCT/EP2022/061159

§ 371 Date: Nov. 6, 2023

(30) Foreign Application Priority Data
May 6, 2021 (DE) 10 2021 111 863.8

(51) Int. Cl. H01M 50/213; H01M 50/247; H01M 50/519

(52) U.S. Cl. CPC H01M 50/213; H01M 50/247; H01M 50/519; H01M 2220/30

(57) ABSTRACT

A battery system, which is robust for mobile use and fulfils both the mechanical and thermal and electrical demands on a mobile, portable battery system, which are configured to be used in a flexible manner.

The battery system also includes battery modules which in each case have at least one battery cell and one electronic module, at least one string housing, wherein the battery modules are arranged in the at least one string housing, and an external housing, wherein the at least one string housing is arranged in the external housing.

### CROSS-REFERENCE TO RELATED APPLICATIONS

This application is a 35 U.S.C. § 371 National Stage patent application of PCT/EP2022/061159, filed on 27 Apr. 2022, which claims the benefit of German patent application 10 2021 111 863.8, filed on 6 May 2021, the disclosures of which are incorporated herein by reference in their entirety.

### TECHNICAL FIELD

The disclosure relates to a battery system according to an independent claim. The disclosure further relates to a battery module according to another independent claim and a battery string according to a further independent claim.

### BACKGROUND

A battery system usually comprises at least one rechargeable battery cell (also termed a secondary cell) and is used to supply electrically-powered loads with energy in various fields of use without connection to the electrical grid. Possible fields of use for such battery systems for example are the construction industry, maintenance and installation services, mobile catering, professional cleaning services, event technology or film production.

Usually, the loads for which such battery systems are used are movable units and it is correspondingly advantageous if the battery system is also movable. The battery system should accordingly be used for mobile provision of mains voltage here. A battery system of this type must be usable in a particularly flexible manner and be correspondingly light and robust for mobile use even under demanding conditions. In particular, it should be portable and not sensitive to impacts.

Depending on the use case, different configurations of battery systems are conceivable, in which individual battery cells are interconnected with one another in series and/or in parallel, in order to achieve the desired output power, the desired capacitance and a desired voltage profile (DC voltage or AC voltage).

### SUMMARY

The disclosure is therefore based on the advantage of providing a battery system, a battery module and a battery string, which are particularly robust for mobile use and fulfil both the mechanical and thermal and electrical demands on a mobile, portable battery system, which can be used in a flexible manner, particularly well.

The advantage is achieved according to the disclosure using the features of the independent claims. Further advantages and practical embodiments are described in connection with the dependent claims.

A battery system according to the disclosure comprises a plurality of battery modules which in each case comprise at least one battery cell and one electronic module. The battery cells are cylindrical lithium-ion rechargeable batteries in particular. The electronic module in this case has a bridge circuit and a control device in particular. The advantage of combining a plurality of individual battery modules to form a battery system is that, in contrast to an individual battery block, the battery modules are thus present in smaller units and e.g. selectively replaceable.

Furthermore, the battery system comprises at least one string housing, wherein the battery modules are arranged in the at least one string housing. In particular, the battery system has a plurality of string housings, wherein in each case a portion of the battery modules is arranged in one of the string housings. The battery modules are particularly evenly distributed to the individual string housings. If the battery system has e.g. twenty four battery modules and four string housings, then six battery modules are arranged in each string housing. The string housing is used as mechanical protection for the battery modules. One string housing with battery modules arranged therein is referred to as a string or battery string in the following.

The battery system further comprises an external housing, in which the at least one string housing is in turn arranged. If a plurality of string housings are provided, then all string housings are arranged in the external housing.

The modular design of the battery system comprising the battery modules, which are initially combined in at least one string, which is in turn arranged in an external housing, allows a particularly efficient and flexible production and good handleability of the whole battery system. The smaller units in the form of strings combine the individual battery modules, so that these battery modules can be handled better in manufacturing and also in the case of repair. The mechanical protection, the thermal coupling of the battery modules and the electrical connection of the battery modules is realized by means of the string. The modular design at the same time allows the independent optimization of the individual components battery module, string housing and external housing with regards to mechanical, thermal and electrical properties.

The at least one string housing in particular comprises a string base body, in the interior of which the battery modules are arranged, and a string cover for covering the battery modules which are arranged in the interior. The external housing in particular has an external base body, wherein the end faces of the external base body are in each case closed with a cover.

The string housing is made from plastic in particular. The external housing is made from aluminium in particular. The external housing is preferably an extruded profile which can be produced easily and inexpensively. The combination of a plastic housing in an aluminium housing is particularly advantageous with regards to the mechanical properties of the battery system. The plastic allows, due to its elasticity, a certain adaptation in the course of the operating time of the battery system, and the aluminium profile allows long-term rigidity.

In a practical embodiment of the battery system according to the disclosure, the at least one string housing has module accommodating regions for arranging individual battery modules, wherein the battery modules can be inserted in a module insertion direction into the respective module accommodating region. The module accommodating regions are configured such that the battery modules are positively fixed therein transversely to the module insertion direction and thus are arranged particularly securely in the string housing.

In particular, the battery modules are arranged in a row in a string housing. Also conceivable is the arrangement of battery modules in a plurality of rows. The insertion direction may be transverse to the direction of the row, so that the battery modules can be inserted into the string housing as simultaneously as possible during the production of the battery system.

In particular, the adjacent module accommodating regions are separated from one another by walls. The walls are in this case adapted to the outer contour of the respective battery module. In particular, both the outer contour of the respective battery module and the inner contour of the walls of the module accommodating region, which inner contour bears against the same, have a rectangular geometry with rounded corners in a plan view. Thus, a particularly good thermal coupling of the battery modules to the string housing and stable mounting of the battery modules with respect to shocks are achieved. Perpendicular to the module insertion direction, in a plan view of the module accommodating regions, the walls which separate the two module accommodating regions from one another, are configured such in this case that in a central region, in which the battery module has a straight external wall, only one straight wall section is formed, wherein battery modules bear against both sides of the wall section. In the region of the rounded corners, the wall has a type of y geometry and is split into two curved wall sections.

As also explained in detail in the following, the string housing has two continuous external walls, which run in straight lines and from which the inner wall sections extend inwards. Particularly in the region of the two curved wall sections, a type of “bridging” is created by the external wall. The two curved wall sections and the external wall then enclose a triangular opening. Overall, the string housing is structured such that it has continuous external walls along the rows of the battery modules, i.e. in the direction in which the greatest loading on the battery modules acts, as the weight of the battery modules acts in an additive manner here, which external walls absorb forces acting on the battery system and guide them past the battery modules.

In particular, in a manner corresponding to the outer contour of the battery modules, the module accommodating regions have at least one wall which runs obliquely to the module insertion direction. Here, angles in the range of 0.2° to 5° and in particular in the range of 0.4° to 0.6° and preferably of 0.5° can be formed between the module insertion direction and the wall. In an advantageous embodiment, all walls run obliquely to the module insertion direction. The battery module then has a truncated-cone-like geometry and the module accommodating regions have a geometry corresponding thereto. An insertion chamfer is created due to the oblique design, using which the battery modules can be inserted into the module accommodating regions more easily and are arranged centrally in the same. The insertion of the battery modules into the module accommodating regions is consequently only possible in one direction. Furthermore, the corresponding walls with chamfer bear against one another particularly well, as a result of which the thermal connection for dissipating waste heat from the battery modules is improved.

To optimize the dissipation of waste heat, the battery module and the string housing bear against one another on as many surfaces as possible. In particular, the battery modules are surrounded over their entire perimeter in the respectively corresponding module accommodating region by walls of the string housing. Over the entire perimeter here means that the battery module is completely surrounded at least over a portion of its height by walls of the string housing. As a result, the battery modules are mounted particularly well with respect to shocks and vibrations. The walls define a defined spacing between the battery modules, which spacing fulfils the requirements for an electrical and thermal separation.

The dissipation of waste heat is improved in particular in that the string housing is at least partially open on one side. In particular, the string housing is completely open on the side from which the battery modules are pushed into the string housing. On this open side, the battery modules then bear over a large area against the external housing, which constitutes a large area for heat dissipation. The side opposite the open side is in particular closed using the string cover.

In a further practical embodiment of the battery system according to the disclosure, the battery modules and the string housing have poka-yoke features which correspond to one another. In particular, the battery modules in each case have a projection on their external wall and an opening corresponding to the projection is formed in the string housing in the external wall. The battery module can then only be inserted into the string housing in one orientation, in which the projection can be arranged in the opening. Thus, already at an early point in time in the assembly of the battery system, the correct installation of the battery modules is achieved.

Furthermore, a plurality of ribs, which are spaced from one another, can be arranged on at least one external wall of the string housing. The ribs are used for mounting the string housing in the external housing and are used at the same time as tolerance compensation for the arrangement of the string housing in the external housing. If the tolerance chain leads to a large spacing or a relatively large clearance prevailing between the external housing and the string housing, then the string housing is supported via the ribs on the inner side of the external housing. If the tolerance chain leads to only little clearance being present between the string housing and the external housing, then the ribs are designed to be fine in such a manner that they shear during insertion of the string housing into the external housing to the extent that the string housing is supported in the external housing. The ribs are in particular arranged on the two opposite external walls of the string housing and ensure support of the string housing in the external housing in a lateral direction perpendicular to a string insertion direction of the string housing into the external housing.

In a further practical embodiment of the battery system according to the disclosure, the battery modules are electrically connected to one another inside the string housing and only one connection for the power input, one connection for the power output and one connection for signal transmission lead out of the string housing. Thus with regards to electrical connection, the strings also form a unit which is as closed as possible and can be connected via just three contacts.

In particular, the connection for signal transmission is designed as a flexible printed circuit board (flex PCB). The flexible printed circuit board runs in a meandering manner in particular. Overall, a satisfactory tolerance compensation is therefore realized between two connections of the printed circuit board to the respective battery module.

As an alternative or in addition to that, the connection for the power input and/or the power output is designed in such a manner that it is realized inside the string housing as a rigid connector and outside the string housing as a flexible line. The rigid connector is a single stamped part in particular. The connections for the power input or the power output are in each case fastened by screws to a module at the end of a row. Adjacent modules are likewise electrically connected to one another via rigid connectors. Thus, the lines are fixed to the greatest extent inside the string housing. For simpler interconnection of the strings in the external housing, the rigid connectors then merge into flexible lines.

In order to position the previously mentioned connections as securely as possible inside the string housing, the string housing comprises a string cover, wherein the string cover has recesses for the arrangement of at least one connection. In particular, the battery modules also in each case have a module cover which has features—particularly contours and recesses—to guide the connections. The string cover is further open in particular on one side, at which the connections are led out of the string housing. The string cover is arranged on the side of the contacts for connecting the battery modules.

In order to connect the string base body and the string cover to one another, the string cover and the string base body have latching means which correspond to one another in particular. Thus, protruding resilient latches can be formed on the string cover, which latch into corresponding openings in the string base body. The latches can spring out of the openings again by means of pressure on the latches. Thus, the string cover and the string base body are connected to one another in a detachable manner.

Furthermore, the string cover and the battery modules may have latching means, which correspond to one another, in order to connect the battery modules to the string cover. In particular, the battery module has protruding resilient latches which are arranged so as to protrude through an opening in the string cover.

If the string cover has latching means corresponding both to the battery modules and to the string base body, the assembly of the string can take place particularly easily: First, the battery modules are arranged in the string base body in the module insertion direction. After contacting the modules by means of the previously described connections, the string cover can be placed on. In the process, it latches simultaneously to the battery modules and to the string base body, so that subsequently, the battery modules are fastened via the string cover to the string base body.

The string cover is mounted on the string housing in a movable manner in particular. The string cover closes the string base body from the upper side. The movable mounting on the string base body can be realized inter alia by spring washers and/or by a layer made from an elastic material, such as a foam, which is arranged between the string base body and the string cover.

The previously described ribs are primarily used for lateral mounting of the string housing in the external housing in a first direction transverse to a string insertion direction (and transverse to the module insertion direction). The movable string cover effects a mounting in the external housing in a second direction transverse to the string insertion direction (and in the module insertion direction). In the case of a combination of ribs and a movable string cover, the string is mounted particularly well in two directions with respect to shocks and vibrations in the external housing which act on the battery module.

In a further practical embodiment, the external housing has at least one string accommodating region which is used for the arrangement of at least one string housing. Preferably, a plurality of string housings and corresponding string accommodating regions are provided. The individual string accommodating regions are particularly formed as rectangular openings which are separated from adjacent string accommodating regions by means of a wall. In the string accommodating regions, the strings are accommodated positively transverse to the module insertion direction. The dissipation of the waste heat from the strings can take place efficiently via the string accommodating region. In particular, the support of the string housing takes place, as described above, via the ribs and the movable cover.

In particular, the string insertion direction does not correspond to the module insertion direction and the string insertion direction is preferably perpendicular to the module insertion direction. The mounting of the battery modules and the dissipation of the waste heat from the battery modules is facilitated as a result.

The mechanical stability of the external housing is improved in particular in that the external housing has at least one cross connection which extends transversely to a string insertion direction (SE) of the string housing into the external housing. The cross connection is arranged at the end inside the external base body in particular. In particular, the cross connection is a plate which is welded into the external base body. The cross connection can be used as a stop for the strings. As also explained in detail in the following, the cross connection is arranged such that the cross connection is used for the absorption of force and diversion of force for control electronics. A cross connection may also be an external cover for the external base body.

In order to protect the battery modules from mechanical influence, the string housing is arranged in the external housing in such a manner that at least one external wall of the string housing, which external wall extends in the string insertion direction (SE), directly connects two cross connections of the external housing to one another. In particular, an external cover and a cross connection, which is arranged inside the external housing, are connected to one another directly. Here, directly means that the two cross connections are connected to one another on the shortest path by a straight, continuous external wall of the string housing. Particularly against the background that the battery modules and the module accommodating regions have rounded corners and curved wall sections, the external wall, which extends straight, guides the force past the battery modules.

In particular, a control device for activating the strings and therefore the battery modules is arranged in the external housing. The control device is in particular arranged on a cross connection, which extends in the external base body, and the cross connection effects a diversion of force around the control device. The control device particularly comprises at least one printed circuit board which has connecting elements for the electrical connection of the strings.

Connectors for connecting the battery system to a load are further arranged on the external housing. In particular, the external housing has a socket for connecting a plug of a load. Here, a conventional socket for the respective geographical area of use is provided in particular. In addition, a connector is provided, via which the battery modules can be connected to the mains for charging. Yet further connectors, such as for example a USB connector may be arranged on the external housing.

In particular, the external housing further has a switch. The switch is used in particular for switching the battery system on and off and/or for adjusting further modes, such as for example coupling to a different device or a transport mode. This may be a toggle switch or else a rotary knob.

Furthermore, it is practical if the external housing has a status indicator having at least one lamp, such as an LED, which displays the state of charge and/or operating state of the battery system.

The disclosure also relates to a battery module. A battery module is claimed independently in this case. The features of the battery module may however also be claimed in connection with a battery system as described previously. In particular, the battery module is suitable for arrangement in a string for building a battery system.

A battery module according to the disclosure has a module housing, at least two battery cells, which are arranged in the module housing, and an electronic module. The battery cells are cylindrical lithium-ion rechargeable batteries in particular. The battery module comprises six battery cells in particular. The electronic module comprises a bridge circuit and a control device in particular. The individual battery cells are connected to one another via cell connectors, wherein the cell connectors have tabs which extend in an axial direction, the free end of which tab is arranged on the side of the electronic module in each case. The free ends of the tabs in each case protrude with respect to adjacent regions. The cell connectors can be contacted at the free ends, in particular, a printed circuit board can be plugged onto all cell connectors and connected (soldered) to the same simultaneously. Thus, the production outlay is greatly reduced and in particular, no cables are necessary.

The tabs are at least partially surrounded by a shoulder section of the module housing in such a manner that the shoulder sections, which are spaced from the free end of the respective tab, form a bearing surface. The shoulder sections are used for positioning the tabs of the cell connectors and define a substantial bearing surface for a printed circuit board which is plugged onto the tabs. The printed circuit board and the battery cells then have a defined spacing from one another.

In order to connect the tab and the electronic module, particularly in the form of a printed circuit board, to one another in as simple a manner as possible, the free end of at least one tab and preferably all tabs have an insertion chamfer. An insertion chamfer facilitates the insertion of the tabs into recesses in the electronic module or the printed circuit board, which are provided therefor.

To connect the module housing to a module cover, the module housing has projections which are arranged to protrude through corresponding openings in the module cover, wherein the projections are deformed by heating in such a manner after passing through that the module cover and the module housing are securely connected to one another. With this type of connection by thermoplastic staking, the module housing and the module cover are connected to one another particularly securely in a positive and materially-bonded manner.

In particular, the projections also protrude through the electronic module (printed circuit board), which is arranged between the module housing and the module cover. The projections are then also used for centring the electronic module. After the thermoplastic staking, the module housing, module cover and electronic module are then securely fixed with respect to one another.

For facilitated insertion of the projections into the module cover and the electronic module, the same may additionally have insertion chamfers.

In particular, the battery module comprises a module housing and a module cover, wherein the module cover has a recess for pouring in potting compound for protecting the electronic module and wherein the module cover defines a frame for the potting compound. The module cover in particular covers the electronic module which is arranged in the module housing. Potting compound can be poured into the recess to protect the electronics. The region into which the potting compound can flow is defined and delimited by the edge of the recess or the material thickness of the cover. In particular, electrical connectors which lie outside the recess are kept free from the potting compound.

In a practical embodiment of the battery module according to the disclosure, the module cover has elements for holding and/or guiding lines. First, to guide a flexible printed circuit board, which is shaped in a meandering manner, a correspondingly meandering elevation can be formed on the module cover on which the printed circuit board rests. A channel may be formed in the module cover for guiding and holding a power connection, in which channel a power connection is at least partially enclosed.

For the further installation of the battery module, e.g. into a string housing, at least one external wall of the module housing can be aligned obliquely to an axial direction. Also, the string housing or the string cover may have latching means for detachable fastening of the battery module to a string housing. Reference is made to the previous description with respect to the advantages of these features.

The disclosure also independently relates to a battery string or string. Wherein here also, all of the previously mentioned features in connection with the battery system relating to the battery string or string can also be used in each case for independently claiming a battery string or string. The battery string is in particular suitable for arrangement in an external housing and for forming a battery system as described previously.

A battery string comprises a plurality of battery modules which in each case comprise at least one battery cell and one electronic module. As described previously, the battery cells may be cylindrical lithium-ion rechargeable batteries. The electronic module comprises a bridge circuit and a control device. The battery string has a string housing having a string base body and a string cover, wherein module accommodating regions are formed in the string base body, into which the battery modules can be inserted in a module insertion direction (ME). The battery modules are in particular mounted in the string housing in at least two directions. Further features of a battery string can be drawn from the preceding description.

### BRIEF DESCRIPTION OF THE DRAWINGS

Further practical embodiments and advantages of the disclosure are described in the following in connection with the drawings. In the figures:

FIG. 1 shows a battery module in a perspective view from obliquely above,

FIG. 2 shows the battery module from FIG. 1 in a side view,

FIG. 3 shows an upper section of the battery module from FIG. 1 in detail in a perspective view from obliquely above,

FIG. 4 shows the upper section from FIG. 3 without module cover and electronic module,

FIG. 5 shows the region labelled with V from FIG. 4 in an enlarged illustration,

FIG. 6 shows a string in an exploded illustration,

FIG. 7 shows the string from FIG. 6 in a perspective illustration from obliquely above,

FIG. 8 shows a string base body in a perspective view from obliquely above,

FIG. 9 shows a string cover in a perspective view from obliquely below,

FIG. 10 shows a battery system according to the disclosure in an exploded view,

FIG. 11 shows an external base body in a perspective view from obliquely at the front, and

FIG. 12 shows the battery system from FIG. 10 in a sectioned illustration according to section line XII-XII from FIG. 10 (x-z plane).

### DETAILED DESCRIPTION OF THE DRAWINGS

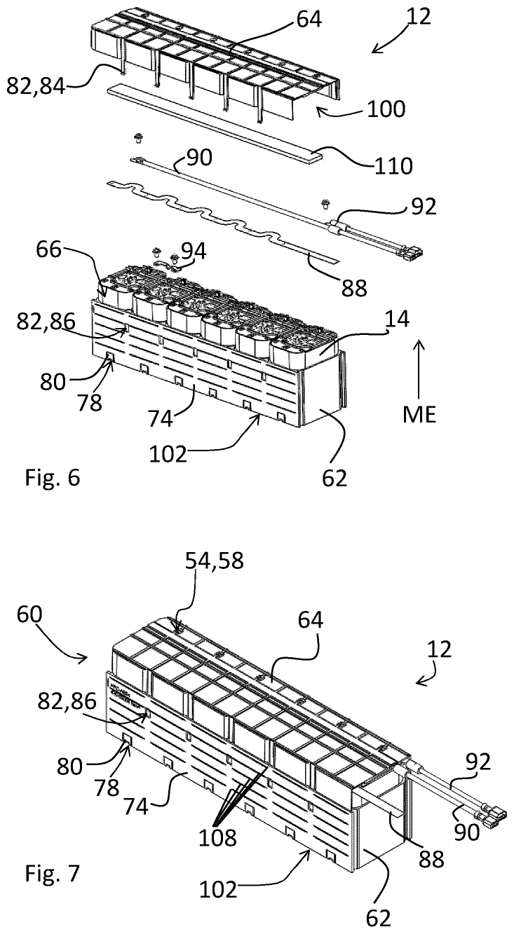

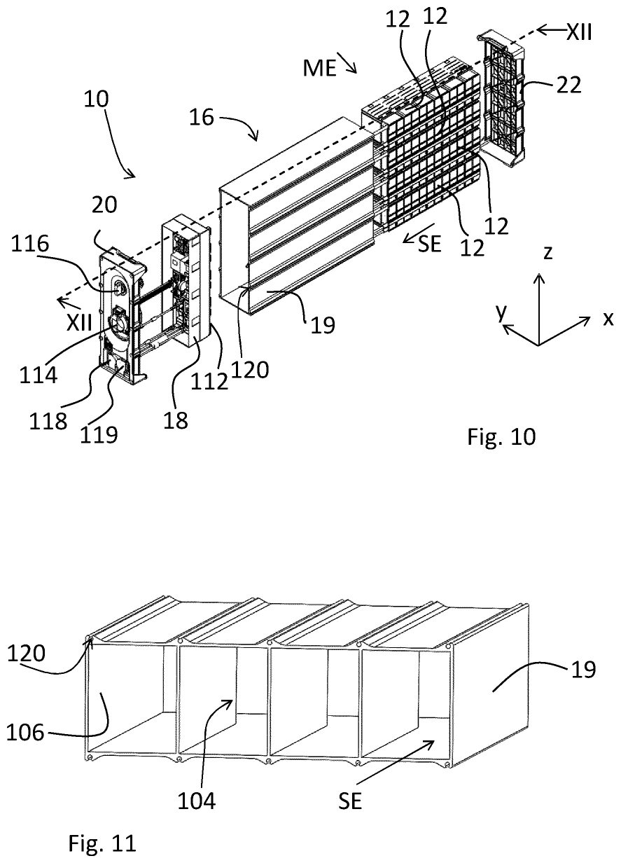

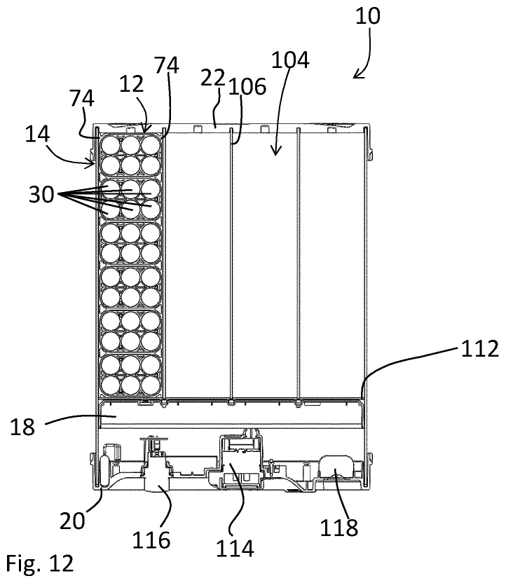

In FIG. 10, the battery system 10 is shown in an exploded illustration. The battery system 10 is built in a modular manner. It has four strings 12 which comprise a plurality of battery modules 14 (not visible here, cf. FIG. 6, FIG. 12). The strings 12 are in turn arranged in an external housing 16. A control unit 18 is further arranged in the external housing 16. The external housing 16 has an external base body 19, which is closed on both sides at the end faces with external covers 20, 22.

The individual components are explained in detail in the following.

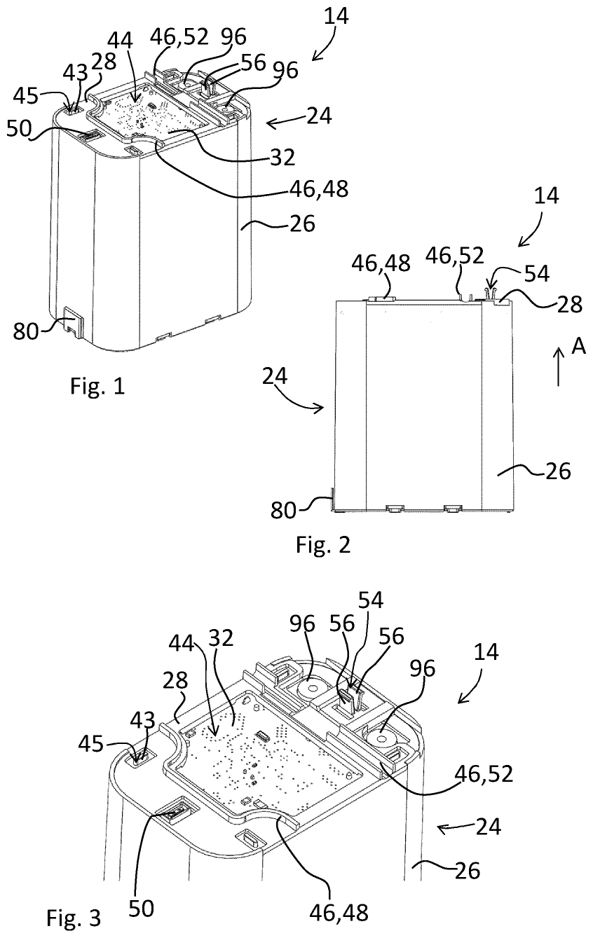

In connection with FIG. 1 to FIG. 5, a battery module 14 is first explained in detail. The battery module 14 comprises a module housing 24 having a module base body 26 and a module cover 28. In the present case, the battery module 14 comprises six battery cells (not visible here). It can be seen in FIG. 13 that a battery module 14 has six cylindrical battery cells 30 (lithium-ion rechargeable batteries here). The battery module 14 further comprises an electronic module 32. The battery module 14 has an axial direction A (cf. FIG. 2).

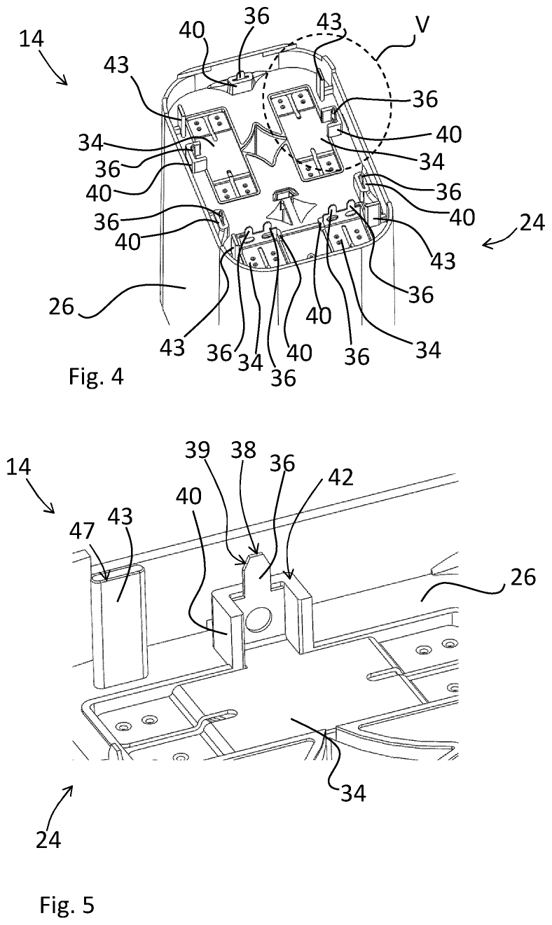

In FIG. 4, the battery module 14 is illustrated without module cover 28 and without electronic module 32. The battery cells 30 are connected to one another via rigid cell connectors 34 and it can be seen well in FIG. 5 that the cell connectors 34 have tabs 36 which extend in the axial direction and have a free end 38. In the present case, seven cell connectors 34 are provided for contacting the six battery cells 30, which cell connectors have nine tabs 36 in total for contacting. In addition to the voltage pick-up for battery management, power transfer to the electronic module 32 also takes place via the cell connectors 34, which have two tabs 36. In this case, the module base body 26 has a plurality of shoulder sections 40, which at least partially surround the tabs 36, wherein one bearing surface 42 of the shoulder section 40 is arranged to be spaced from the free end 38 of the tabs 36. This can be seen well in detail in FIG. 5. The bearing surface 42 is used as a stop for the electronic module 32, which is realized as a printed circuit board here and is pushed onto all tabs 36 simultaneously. The shoulder sections 40 cause the electronic module 32 to have a defined spacing from the battery cells 30 or the cell connectors 34. For facilitated plugging of the printed circuit board 32 onto the tabs 36, the tabs 36 have insertion chamfers 39 at their free ends 38.

The module housing 24 furthermore has projections 43 which are used for connecting the module housing 24 to the module cover 28 and the electronic module 32. The electronic module 32 and the module cover 28 are pushed onto the projections 43. The projections protrude through corresponding openings in the electronic module 32 and corresponding openings 45 in the module cover 28. After pushing on the electronic module 32 and the module cover 28, the ends of the projections 43 are heated or melted, which leads to a deformation of the projections and to a secure positive and materially-bonded connection between module housing 24, electronic module 32 and module cover 28 (thermoplastic staking). The projections 43 additionally have insertion chamfers 47 at their ends.

In FIGS. 1 to 3, the battery module 14 is shown in detail with the module cover 28 and the electronic module 32 lying therebelow. The module cover 28 has a central recess 44. The recess 44 defines a region in which the electronic module 32 is covered with potting compound (not illustrated). Due to the material thickness of the module cover 28, the module cover 28 forms a frame around the recess 44 and prevents potting compound from reaching the electrical contacts 50 outside the recess 44.

Furthermore, the module housing 28 has elements 46 for guiding and holding connections. A curved elevation 48 is used for positioning a meandering flexible printed circuit board (cf. FIG. 6). The printed circuit board is connected via the contacts 50 to the battery modules 14. In addition, channel-shaped structures 52 are formed on the module cover 28, which are used for guiding and fixing power connections (cf. FIG. 6).

The module cover 28 furthermore has latching means 54 which are used for fastening the battery module 14 in a string 12. To this end, two resilient latches 56 are formed on the module cover 28. These interact with a corresponding latching means 54 in the form of openings 58 in a string cover (cf. FIG. 9).

It can be seen in the side view in FIG. 2 that the external walls of the battery module run at an angle to the axial direction. This facilitates arrangement of the battery module 14 in a string housing and large-area bearing of the outer side of the battery module 14 in the string housing causes good thermal coupling and mechanical protection.

Details concerning a string 12 are explained in the following in connection with FIGS. 6 to 8.

A string 12 is in this case illustrated in FIGS. 6 and 7. A string 12 has a string housing 60 and battery modules 14 which are arranged in the string housing 60. The string housing 60 is formed from a string base body 62 and a string cover 64. Six battery modules 14 according to FIGS. 1 to 5 are arranged in the string housing 62. In the embodiment shown, the six battery modules 14 are arranged in a row in the string housing 60.

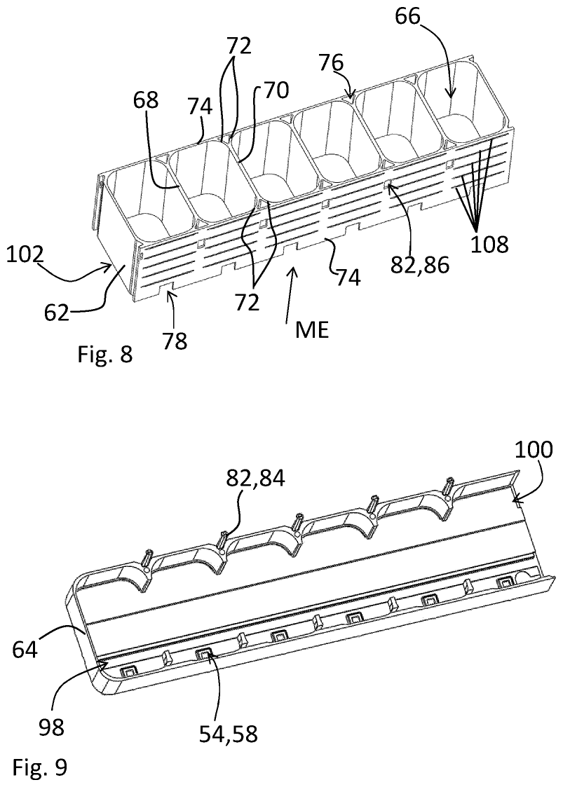

To arrange the battery modules 14 in the string housing 60, the string base body 62 has module accommodating regions 66 which correspond to the battery modules 14. A battery module 14 is inserted into the respective module accommodating region 66 in a module insertion direction ME. The string base body 62 is illustrated in an isolated manner in FIG. 8. The module accommodating regions 66 are separated from one another by walls 68. The module accommodating regions 66 are adapted to the outer contour of the battery modules 14 and likewise have walls 68 which run obliquely to the module insertion direction ME or axial direction A of the battery modules 14.

The battery modules 14 have a rectangular geometry with rounded corners in a plan view. The module accommodating regions 66 are also correspondingly designed. Thus, the string base body 62 has wall sections 70 which extend straight. Two separate curved wall sections 72 extend in the region of the rounded corners, which wall sections together with the straight wall sections 70 form a “y”.

Furthermore, the string base body 62 here has two continuous external walls 74 which extend straight and continuously. That is to say also, the two curved wall sections 72 are “bridged” by the external wall 74 and a triangular opening 76 is formed, which is delimited by the two wall sections 72 and the external wall 74. In the direction of the row, the external walls 74 form the first point of application in each case.

The battery modules 14 are in each case surrounded over their entire perimeter over a portion of their height by the straight wall sections 72, the curved wall sections 74 and the external walls 74.

The string base body 62 and the battery modules 14 have poka-yoke features which correspond to one another. A recess 78 is formed here in the string base body 62 on a lower edge of an external wall 74, which recess interacts with a projection 80 (cf. FIG. 1) on only one side surface of the battery module 14. The battery module 14 can only be inserted completely into the string base body 62 if it has the correct orientation and is not rotated by 180° about the module insertion direction ME.

The string housing 60 also has a string cover 64. The string cover 64 is used inter alia for fastening the battery modules 14 in the string 12. As is shown in the separate illustration of the string cover 64 in FIG. 9, the string cover has six openings 58 as corresponding latching means 54, through which the protruding latches 56 on the module cover 28 are passed. During insertion, the latches 56 yield elastically with respect to one another and when the ends have been passed through the opening 58, the latches 56 rebound again. The battery modules 14 and the string cover 64 are connected by means of these corresponding latching means 54. The connection of the string cover 64 (and therefore indirectly the connection of the battery modules 14) to the string base body 62 likewise takes place by means of latching means 82. To this end, resilient latching elements 84 are provided on the string cover, which extend in the direction of the string base body and are guided from inside through the triangular opening 76 and rebound outwards into an opening 86 in the external wall 74 of the string base body 62.

The strings 12 furthermore have a plurality of connections 88, 90, 92 for contacting the battery modules 14. A first connection 88 is used for signal transmission and is a flexible printed circuit board here. The printed circuit board 88 runs in a meandering manner and thus provides an additional flexibility between the contacts 50. The module cover 28 has corresponding guiding structures 46, 48 for guiding the meandering printed circuit board 88 (cf. FIG. 3). Furthermore, a power input and a power output are provided as second connection 90 and third connection 92. The individual battery modules 14 are connected to one another by rigid module connectors 94. The module connectors 94 and the power input 90 and the power output are screwed to the contacts 96. The power input 90 and the power output 92 are formed as rigid connectors inside the string housing 60 and as flexible cables outside the string housing (cf. FIG. 7). The first connection 90 is guided in the channel-shaped structure 52 on the module cover 28. In addition, a recess 98 is formed in the string cover 64, which recess fixes the power input 90 from above. FIG. 7 also shows that a string 12 is only connected via three connections 88, 90, 92, the contacting of the individual battery modules 14 takes place inside the string housing 60. The string cover 64 has an open side 100 for leading the connections out.

The string housing 60 is completely open on one side—here the underside 102 opposite the string cover 64. As becomes clear from viewing FIGS. 6, 8 and 10 together, the battery modules 14 bear against the external housing 16 over their whole area and waste heat can therefore be dissipated particularly effectively.

The arrangement of the strings 12 in the external housing 16 is described in more detail hereinafter.

The strings 12 are in turn arranged in the external housing 16. In the present case, four identically structured strings 12 are arranged in the external housing 16 (cf. FIG. 10). The external base body 19 has string accommodating regions 104, into which the strings 12 can be inserted into the external base body 19 in a string insertion direction SE. The string accommodating regions 104 are formed as rectangular openings which are separated from one another by walls 106. The string insertion direction SE is aligned to be perpendicular to the module insertion direction ME.

The string housing 60 has a plurality of features for mounting the string housing 60 in the external base body 19 or in the respective string accommodating region 104 in as stable and damped a manner as possible. First, a plurality of ribs 108 are formed on the two external walls 74 of the string base body 62 for laterally supporting the string housing 60. In the embodiment shown, six times six ribs 108 are formed in each case on the external walls 74. Using the ribs 108, the string housing 60 is supported on the walls 106 laterally, in a first direction transverse to the string insertion direction SE. The ribs 108 are designed in such a manner that in the case of maximum clearance between string housing 60 and walls 106 of the respective string accommodating region 104, the ribs 108 effect the mounting precisely. If the clearance is smaller, then the ribs 108 can be at least partially sheared during insertion of the string housing 60 into the respective string accommodating region 104.

The mounting of the string 14 in the string accommodating region 104 in the second direction transverse to the string insertion direction SE takes place by means of the movable connection of the string cover 64. An elastic element 110, here a strip made from foam—which is elastically deformable, is arranged between the string cover 64 and the string housing 62.

FIG. 10 also shows that the external housing 16 is in each case closed at the end by the external cover 20, 22. The control device 18 is arranged in the external base body 19 on the side on which the connections 88, 90, 92 of the strings 12 are arranged. The battery modules 14 are electrically connected to the control device 18 via the connections 88, 90, 92.

A cross connection 112 is further arranged in the external base body 19. The cross connection 112 is realized as a plate and welded to the external base body 19. A section through the battery system 10 is illustrated in FIG. 12. The cross connection 112 extends over the entire cross-sectional area of the external base body 19 and constitutes an end-side delimitation of the string receptacles 104. The cross connection 112 is on the one hand used as a stop for the strings 12 and on the other hand for the arrangement of the control device 18. The cross connection 112 is used for the diversion of force for the control device 18.

The supporting effect of the external walls 74 of the string housing 60 additionally becomes clear in connection with FIG. 12. The external walls 74 extend directly from the cross connection 112 to the cover 22, which here is also used as a cross connection. Forces which act along the row in the string insertion direction SE are introduced into the external walls 74 of the string base body 60 directly and guided past the battery modules 14.

In addition, a connector 114 for a load is formed in the external cover 20, here in the form of a socket. The battery system 10 has a rotary knob 116, by means of which the desired battery mode can be set. Likewise, a connector 118 for charging the battery cells 30 is formed on the external cover 20. A load can likewise be connected to a further connector 119 and this may be configured differently from the connector 114.

The external covers 20, 22 are connected to the external base body 19 by means of screws which are screwed from the end face through the external cover 20, 22 into the external base body 19. To this end, external screw channels 120 are formed on the external base body 19.

1. A battery system comprising:
a plurality of battery modules which in each case comprise at least one battery cell and one electronic module,
at least one string housing, the battery modules being arranged in the at least one string housing, and
an external housing, the at least one string housing being arranged in the external housing.

2. The battery system according to claim 1, wherein the at least one string housing has module accommodating regions for arranging individual battery modules, wherein the battery modules are configured to be inserted in a module insertion direction into the respective module accommodating region.

3. The battery system according to claim 2, wherein, in a manner corresponding to the outer contour of the battery modules-el the module accommodating regions have at least one wall which runs obliquely to the module insertion direction.

4. The battery system according to claim 2, wherein the battery modules are surrounded over their entire perimeter in the corresponding module accommodating region by a plurality of walls.

5. The battery system according to claim 1, wherein the at least one string housing is at least partially open on one side.

6. The battery system according to claim 1, wherein the battery modules and the string housing have poka-yoke features which correspond to one another.

7. The battery system according to claim 1, wherein a plurality of ribs, which are spaced from one another, are arranged on at least one external wall of the string housing.

8. The battery system according to claim 1, wherein the battery modules are electrically connected to one another inside the string housing and only one connection for a power input, one connection for a power output and one connection for signal transmission lead out of the string housing.

9. The battery system according to claim 8, wherein
the connection for signal transmission is designed as a flexible printed circuit board and/or
in that the connection for the power input and/or the power output is designed such that the connection inside the string housing is a rigid connector and the connection outside the string housing is a flexible line.

10. The battery system according to claim 8, wherein the string housing comprises a string cover and wherein the string cover has at least one recess for the arrangement of at least one connection.

11. The battery system according to claim 1, wherein the string housing comprises a string base body and a string cover, wherein
the string cover and the string base body have latching means which correspond to one another, in order to connect the string cover and the string base body to one another,
and/or
the string cover and the battery modules have corresponding latching means, in order to connect the battery modules and the string cover to one another.

12. The battery system according to claim 1, wherein the string cover is mounted on the string base body in a movable manner.

13. The battery system according to claim 1, wherein the external housing has at least one string accommodating region which is used for the arrangement of a string housing, wherein the string housing is configured to be inserted into the external housing in a string insertion direction.

14. The battery system according to claim 1, wherein the string insertion direction is perpendicular to the module insertion direction.

15. The battery system according to claim 1, wherein the external housing has at least one cross connection which extends transversely to the string insertion direction.

16. The battery system according to claim 15, wherein the string housing has at least one external wall, which extends in the string insertion direction and which directly connects two cross connections of the external housing to one another.

17. The battery system according to claim 1, wherein a control device is arranged in the external housing.

18. A battery module having comprising: a module housing, at least two battery cells, which are arranged in the module housing, and an electronic module, individual battery cells being connected to one another via cell connectors and the cell connectors having tabs which extend in the axial direction, the free end of which tab is arranged on the side of the electronic module in each case, wherein the tabs are in each case at least partially surrounded by a shoulder section of the module housing, so the shoulder section, which is spaced from the free end of the respective tab, forms a bearing surface.

19. The battery module according to claim 18, wherein the free end of at least one tab has an insertion chamfer.

20. The battery module according to claim 18, wherein the module housing has projections which are arranged to protrude through openings in a module cover and/or openings in the electronic module, wherein the projections are deformed by heating such a that after passing through that the module cover and the module housing and/or the electronic module and the module housing are securely connected to one another.

21. The battery module according to claim 18, wherein the module housing comprises a module cover, wherein the module cover has a recess for pouring in potting compound for protecting the electronic module and wherein the module cover defines a frame for the potting compound.

22. The battery module according to claim 18, wherein the module cover has elements for holding and/or guiding electrical connections.

23. The battery module according to claim 18, wherein the module cover has latching means for connecting the battery module to a further housing.

24. The battery module according to claim 18, wherein at least one external wall of the module housing is aligned obliquely to the axial direction.

25. A battery string comprising a plurality of battery modules which in each case comprise at least one battery cell and one electronic module, wherein the battery string has a string housing having a string base body and a string cover, wherein module accommodating regions are formed in the string base body, into which module accommodating regions the battery modules are configured to be inserted in a module insertion direction.
